(19) United States
(12) Patent Application Publication
(10) Pub. No.: US 2011/0300479 A1
(43) Pub. Date: Dec. 8, 2011

(54) TONER COMPOSITION WITH BROAD FUSING TEMPERATURE RANGE AND PROCESS FOR PREPARING THE SAME

(75) Inventors: Eui Joon Choi, Gyeonggi-do (KR); Hyun Nam Yoon, Towaco, NJ (US)

(73) Assignee: EXAX TONER, INC, Gyeongsangbuk-do (KR)

(21) Appl. No.: 13/202,093

(22) PCT Filed: Aug. 28, 2009
(86) PCT No.: PCT/KR2009/004813

§ 371 Date: Aug. 17, 2011

(30) Foreign Application Priority Data
Feb. 20, 2009 (KR) 10-2009-0014266

(51) Int. Cl. G03G 9/08

(52) U.S. Cl. 430/108.2; 430/110.3; 430/108.4; 430/108.8

(57) ABSTRACT

The present invention relates to a toner composition with a broad fusing temperature range and a process for preparing the same. The toner composition according to the present invention creates entanglement between adjacent polymer chains using a non-linear polyester resin having a branch structure, provides elasticity to molten materials by the branch structure when the resin is molten, prevents the molten materials from being transferred to the surface of a roller at a high temperature, and thereby increases the maximum fusing temperature. Therefore, as the average branch number per polyester resin increases, the maximum fusing temperature rises and the fusing temperature range of the toner composition can be widened.

### TECHNICAL FIELD

The present invention relates to a toner composition having a broad range of fusing temperature and a method of producing the toner composition.

### BACKGROUND ART

A fusing temperature range of a toner means the scope of temperature that allows the operation of a fusing device in a printer using the toner. In a widely used fusing device of heated dual roller type, the lowest fusing temperature is a temperature at which the toner is completely molten and begins to bond to paper alone without adhering to the hot surface of the roller, and the highest fusing temperature is a temperature at which a molten material of the toner begins to be transferred to the hot surface of the roller due to its excessively low viscosity. In general, as a fusing temperature is broader, the toner may be effectively used for more various laser printers.

Recently, in order to meet market's increasing demands for toners adapted to high-speed printing, a variety of methods for producing a toner composition using a polyester resin have been studied. These methods may be mainly classified into mechanical methods and chemical methods.

A mechanical (i.e., pulverized type) method performs a mixing at high temperature and pressure without using a solvent. It is therefore possible to produce a toner composition even though there is any insoluble component. However, in case where a polyester toner composition is mechanically produced using a linear polyester resin, there is a problem that the highest fusing temperature is excessively low even though the lowest fusing temperature is sufficiently low. Accordingly, in order to increase the highest fusing temperature, a method for producing a toner composition by mixing a low molecular weight resin and a high molecular weight resin or by adding a polymer gel component to a low molecular weight resin has been proposed. However, although this method widens a fusing temperature range of the toner, it may have another problem of failing to produce a toner composition with a uniform and small sized spherical shape.

A chemical method includes a dispersion polymerization method and a milling method. A dispersion polymerization method is to prepare a polymer resin in the state where monomers are dispersed in solvent. However, this method not only fails to produce polyester resin with a high molecular weight, but also fails to easily add a polymer gel component to a polyester resin with a low molecular weight. Therefore, if a toner composition is produced using a polymer resin prepared through a dispersion polymerization method, it is not easy to obtain a broad fusing temperature range of a toner composition. A milling method is to produce a toner composition by using a polymer solution. However, in case of a polymer resin with a high molecular weight or having a gel component, this method fails to completely dissolve a polymer resin in an organic solvent due to low solubility. Therefore, if a toner composition is produced using a polymer resin prepared through a milling method, it is not easy to obtain a broad fusing temperature range of a toner composition. As discussed above, a chemical method for producing a toner composition causes a relatively narrower fusing temperature range of a toner.

Meanwhile, a nonlinear polyester resin having a branch structure causes entanglement between adjacent polymer chains and thereby gives elasticity to a molten material of resin. It is therefore expected that a toner produced using such a nonlinear polyester resin may prevent a molten material of a toner from being transferred to the hot surface of the roller and this may increase the highest fusing temperature. However, studies of a method for increasing the highest fusing temperature of a toner composition by using a nonlinear polyester resin having a branch structure are still in its infancy.

Accordingly needed are research and development for a toner composition having a broad range of fusing temperature by increasing the highest fusing temperature through the use of a nonlinear polyester resin having a branch structure.

### DETAILED DESCRIPTION OF THE INVENTION

### Technical Subject

During studies of a toner composition having a broad fusing temperature range, the present inventors produced a toner composition using a nonlinear polyester resin with a branch structure, verified that the highest fusing temperature of this toner composition was considerably increased and therefore a fusing temperature range became broader, and then completed this invention.

### Solutions for the Technical Subject

The present invention is to provide a toner composition having a broad fusing temperature range and a method of producing the toner composition

### Best Mode for Carrying Out the Invention

The present invention provides a toner composition that comprises a nonlinear polyester resin having a branch structure in which an average branch number per chain is 1.0˜3.0, a colorant, a wax, a light stabilizer, and a charge control agent. The toner composition has the highest fusing temperature of 220° C. The polyester resin has a glass transition temperature (Tg) of 45˜80° C., a number-average molecular weight (Mn) of 3000˜8000, a weight-average molecular weight (Mw) of 6000˜40000, and a molecular weight distribution index of 2.0˜13.0. The toner composition has a spherical particle shape, a volume average particle size of 3˜10 μm, and a span value of 0.1˜0.8.

Additionally, the present invention provides a method for producing a toner composition, the method comprising:

First step of preparing a resin mixture in which a nonlinear polyester resin having a branch structure in which the average branch number per chain is 1.0˜3.0, a colorant, a wax, a volatile processing aid, a light stabilizer, and a charge control agent are mixed and then heated at a temperature of 60˜95° C. in circumfluent conditions,

Second step of preparing a dispersed solution in which a polar solvent, a surfactant, and a thickener are mixed and then heated to a temperature of 60˜95° C. in circumfluent conditions,

Third step of preparing a resin mixture dispersed solution in which the resin mixture prepared in the first step is added to the dispersed solution prepared in the second step and then dispersed at a temperature of 60˜95° C.,

Fourth step of preparing the resin mixture with no processing aid in which the resin mixture dispersed solution prepared in the third step is agitated at a temperature of 60˜95° C. so as to volatilize the processing aid,

Fifth step of preparing toner particles in which the resin mixture with no processing aid prepared in the fourth step is cooled to a room temperature and filtered and then the toner particles are washed and dried, and

Sixth step of coating surfaces of the toner particles prepared in the fifth step with a flow improvement agent.

Now, components of the toner composition according to the present invention will be described in detail.

In the toner composition of this invention, the polyester resin is a nonlinear polyester resin having a branch structure in which the average branch number per chain is 1.0˜3.0, the glass transition temperature (Tg) is 45˜80° C., the number-average molecular weight (Mn) is 3000˜8000, the weight-average molecular weight (Mw) is 6000˜40000, and the molecular weight distribution index is 2.0˜13.0.

The nonlinear polyester resin having a branch structure creates entanglement between adjacent polymer chains and thereby gives elasticity to a molten material when the resin is molten. Therefore, a toner produced using such a nonlinear polyester resin may prevent a molten material from being transferred to the hot surface of the roller, so that the highest fusing temperature may be increased. Preferably, the average branch number per chain of the polyester resin is 1.0˜3.0. If the average branch number per chain of the polyester resin is more than 3.0, the molecular weight of polymer may become excessively greater or an actual cross-link between polymer chains may occur. Therefore, the resin may not be sufficiently dissolved in a process solvent, so that a toner composition may not be stably produced. If the average branch number per chain of the polyester resin is less than 1.0, entanglement between chains may not be formed. Therefore, a molten material of the toner may not have elasticity, so that the highest fusing temperature may not be sufficiently increased.

The nonlinear polyester resin having a branch structure includes a first monomer component having three or more functional groups of carboxyl and hydroxyl and a second monomer component having bi-functional groups, and is produced by polymerizing these monomers through a melt condensation process. The first monomer component having three or more functional groups of carboxyl and hydroxyl may be trimellitic acid, trimesic acid, 1,3,5-tricarboxybenzene, 5-hydroxy-isophthalic acid, dihydroxy-benzoic acid, 1,3,5-benzenetriol, 1,2,4-benzenetriol, 1,3,5-benzene triacetate, or glycol. The first monomer component having four or more functional groups of carboxyl and hydroxyl may be tetrahydroxy benzophenone. The second monomer component having bi-functional groups may include at least one selected from monomer components having functional groups of dicarboxyl acid, diol, and hydroxycarboxyl acid. The monomer component having dicarboxyl acid functional groups may include, but not limited to, at least one selected from the group consisting of terephthalic acid and derivatives thereof, isophthalic acid and derivatives thereof, fumaric acid, succinic acid, glutaric acid, adipic acid, sebacic acid, cyclohexane dicarboxyl acid, naphthalene dicarboxyl acid and derivatives thereof, and 1,2-bis(4-carboxyphenoxy)ethane. The monomer component having diol functional groups may include, but not limited to, at least one selected from the group consisting of ethylene glycol, isomer of propylene glycol, isomer of butylenes glycol, isomer of pentanediol, isomer of hexanediol, isomer of cyclohexane dimethanol, hydroquinone and derivatives thereof, 2-methyl-1,3-prophandiol, neopentyl glycol, condensation polymer of bisphenol-A and ethylene oxide, and condensation polymer of bisphenol-A and propylene oxide. The monomer component having hydroxycarboxyl acid functional groups may include, but not limited to, at least one selected from the group consisting of glycolic acid, lactic acid, ε-caprolactone, γ-butyrolactone, propiolactone, hydroxypivalic acid, lactone of hydroxypivalic acid, and isomer of hydroxybenzoic acid and derivatives thereof. The average branch number per chain of the polyester resin may be properly regulated through the quantity of the first monomer component having three or more functional groups of carboxyl and hydroxyl.

Preferably, the nonlinear polyester resin having a branch structure has a functional group suitable for interaction with dyes. This functional group may include, but not limited to, at least one selected from the group consisting of sulfonyl, sulfinic, hydroxyl, alkoxy, phosphonic or derivatives thereof, phosphinic or derivatives thereof, thiol, amine, and quaternary amine.

In the toner composition of this invention, the colorant may use dyes, pigment, and mixture thereof. Preferably, the colorant is 1˜15 weight percent of the total weight of the toner composition.

The dyes may be selected from basic dyes, acid dyes, and reactive dyes.

The pigment may be selected from cyan pigment, magenta pigment, yellow pigment, black pigment, white pigment, and mixtures thereof, which are often used commercially, in consideration for color, saturation, brightness, weather resistance, transparency, compatibility with toner resin, etc. As such pigment, yellow colors P.Y. 155, P.Y. 180, P.Y. 74, and P.Y. 93, magenta colors P.R. 57:1, P.R. 184, P.R. 122, and P.R. 269, and cyan color P.B. 15:3 are mostly used. In addition, when another toner for commercial purposes is produced, yellow colors P.Y. 17, P.Y. 97, P.Y. 174, P.Y. 139, and P.O. 34, magenta-toned colors P.R. 146 and P.V. 19, pigment such as P.V. 23, P.V. 19, and P.G. 7, and P.B. 15:4 may be used. Furthermore, black colors SB4, SB7, and SB9 may be used, and titanium oxide may be used as white pigment. These may be properly selected in consideration for color coordinates, darkness of the color, and the like. If the pigment is contained more than 15 weight percent, elasticity of the resin becomes stronger. This may make it difficult to form particles or cause a distribution of grain sizes to be widened. If the pigment is contained less than 1 weight percent, degree of coloring of the toner may be lowered. This may cause inadequate representation of colors in printing. Therefore, the pigment should be selected in view of a physical chemical structure of pigment such as a crystal structure, a crystal size or a chemical composition, and interaction of a physical chemical structure of the resin mixed with the pigment.

In the toner composition of this invention, the wax may use any types of general wax, for example, ester wax, carnauba wax, polyethylene wax, polypropylene wax, bees wax, paraffin wax, or their mixtures. Adding the wax is desirable since toner particles may be fused into a printed matter such as paper or plastic even though no oil is used. Preferably, the wax is 1˜15 weight percent of the total weight of the toner composition. If the wax is contained more than 15 weight percent, agglomeration of the toner may be caused in storage.

In the toner composition of this invention, the light stabilizer may selectively use UV absorbent, hindered amine light stabilizer (HALS), or their mixture, which is typically used. For instance, preferably used are Tinuvin 99-2, Tinuvin 111FD, Tinuvin 123, Tinuvin 144, Tinuvin 292, Tinuvin 326, Tinuvin 328, Tinuvin 329, Tinuvin 384, Tinuvin 400, Tinuvin 411, Tinuvin 900, Tinuvin 928, Tinuvin 1130, or their compounds. Preferably, the light stabilizer is 0.1˜5 weight percent of the total weight of the toner composition.

In the toner composition of this invention, the charge control agent may include at least one of a positive charge control agent, a negative control agent, and their mixture, which are typically used. The charge control agent is properly selected depending on the type of charges to be assigned to the final toner. The positive charge control agent is mainly classified into an azine type and a quaternary ammonium salt type according to its chemical structure. An azine type positive charge control agent having chiefly a black color can be used only for a black toner, whereas a quaternary ammonium salt type having a white powder form is not restricted by toner colors. The negative charge control agent mostly uses a white charge control agent of tert-butyl salicylic acid metallic salt type and a black charge control agent of azo type in a chemical structural aspect. A central metal in tert-butyl salicylic acid metallic salt is chrome, aluminum, zinc, calcium, boron, acetyl boron, or the like, and the azo type generally uses chrome, iron, or the like. Metallic salt contained in the toner may regulate a charging rate, charging quantities, etc. Preferably, the charge control agent is 0.1˜10 weight percent of the total weight of the toner composition. If the charge control agent is contained more than 10 weight percent, excessively many charges may cause image distortion. If the charge control agent is contained less than 0.1 weight percent, a low charging rate and small charging quantities may be invited.

The toner composition of this invention includes, with regard to a total weight thereof, the polyester resin of 75˜95 weight percent, the colorant of 1˜15 weight percent, the wax of 1˜15 weight percent, the light stabilizer of 0.1˜5 weight percent, and the charge control agent of 0.1˜10 weight percent.

Now, a method for producing a toner composition according to the present invention will be described in detail step by step.

The aforesaid first step is to prepare a resin mixture. In this step, a nonlinear polyester resin having a branch structure in which the average branch number per chain is 1.0˜3.0 is mixed with a colorant, a wax, a volatile processing aid, a light stabilizer, and a charge control agent. Then they are heated to a temperature of 60˜95° C. in circumfluent conditions.

The nonlinear polyester resin, the colorant, the wax, the light stabilizer, and the charge control agent, used in the method, are the same as components of the above-discussed toner composition.

The volatile processing aid has a lower boiling point than that of a polar solvent and may not be mixed with the polar solvent to be added later. For instance, the volatile processing aid may include, but not limited to, at least one selected from the group consisting of methyl acetate, ethyl acetate, isopropyl acetate, methyl ethyl ketone, dimethyl ether, diethyl ether, 1,1-dichloroethane, 1,2-dichloroethane, dichloromethane, and chloroform.

The aforesaid second step is to prepare a dispersed solution. In this step, a polar solvent, a surfactant, and a thickener are mixed together and then heated to a temperature of 60˜95° C. in circumfluent conditions.

The polar solvent may include at least one selected from the group consisting of water, glycerol, ethylene glycol, propylene glycol, diethyl glycol, dipropylene glycol, and sorbitol, preferably, water.

The surfactant may use anything having a hydrophilic-lipophilic balance (HLB) of 10 or more. For instance, the surfactant may include, but not limited to, at least one selected from the group consisting of sodium stearoyl lactylate, polyethyl glycol cocamine, polyethylene glycol sorbitan hexanolate, polyethylene glycol dilaurate, steamine acetate, taloamine acetate, glyceryl stearate, polyethylene glycol lanolate, polyethylene glycol palmitate, polypropylene glycol hydroxyethyl cocamine, polyethylene glycol glyceryl laurate, polyethylene glycol stearate, triethyl amine oleate, polyethylene glycol taloamine, sucrose laurate, sodium dodecyl sulfate, potassium dodecyl sulfate, alkyl ammonium chloride, and alkyl ammonium bromide.

The thickener may include, but not limited to, at least one selected from the group consisting of polyvinyl pyrrolidone, anionic copolymer of polyvinyl pyrrolidone, cationic copolymer of polyvinyl pyrrolidone, polyvinyl alcohol, copolymer of polyvinyl alcohol, polyacrylic acid, copolymer of polyacrylic acid, gelatin, chitosan, sodium alginate, alginate, and agar.

The aforesaid third step is to prepare a resin mixture dispersed solution. In this step, the resin mixture prepared in the first step is added to the dispersed solution prepared in the second step and then dispersed at a temperature of 60˜95° C.

The aforesaid fourth step is to prepare the resin mixture with no processing aid. In this step, the resin mixture dispersed solution prepared in the third step is agitated at a temperature of 60˜95° C. so as to volatilize the processing aid.

The aforesaid fifth step is to prepare toner particles. In this step, the resin mixture with no processing aid prepared in the fourth step is cooled to a room temperature and filtered to obtain the toner particles, and then the toner particles are washed and dried.

The aforesaid sixth step is to coat surfaces of the toner particles with a flow improvement agent. In this step, the flow improvement agent is coated on the surfaces of the toner particles prepared in the fifth step, and thereby the toner composition is finally obtained.

The flow improvement agent improves fluidity of particles to be used for a color toner. The flow improvement agent may be hydrophobic silica, alumina, titanium oxide, zinc stearate, magnesium stearate, and the like. This flow improvement agent is coated on the toner particles by using a dry mix or solvent mix technique.

The toner composition produced by the above-discussed method has a spherical particle shape, a volume average particle size of 3˜10 μm, a span value of 0.1˜0.8, and the highest fusing temperature of about 220° C.

The toner composition according to the present invention creates entanglement between adjacent polymer chains by using the nonlinear polyester resin having a branch structure, provides elasticity to molten materials when the resin is molten, prevents the molten materials from being transferred to the hot surface of the roller, and thereby increases the highest fusing temperature. Therefore, as the average branch number per chain of the polyester resin increases, the highest fusing temperature rises, thus allowing the range of a fusing temperature of the toner composition to be widened. This toner composition having a broad range of a fusing temperature may be usefully used for laser printing devices.

### MODES FOR CARRYING OUT THE INVENTION

Hereinafter, embodiments of the present invention will be described more fully. The following embodiments may, however, be exemplary only and should not be considered as a limitation of the present invention.

### PREPARATION EXAMPLE 1

### Preparation of Linear Polyester Resin

A polyester resin has a linear molecular structure, currently used as a standard of a chemical milling method, and allows a cationic dyeing. This polyester resin was polymerized through a melt condensation process.

Dimethyl terephthalate 955.6 g (4.925 mol), dimethyl isophthalate 955.6 g (4.925 mol), sodium salt of dimethyl 5-sulfoisophtalate 44.5 g (0.15 mol), and 1,2-propylene glycol 1520 g (20 mol) were filled into a glass reactor of 10 l equipped with a peddle type agitator and a fractional distillation column of 20 cm. Titanium tetra isopropoxide 1.4 g and IGANOX 1010 (commercially available from Clariant Corporation, East Hanover, N.J.) 5.0 g were used as ester interchange catalyst. Reactants were inputted at a room temperature and purified using argon for about one hour. Then mixed reactants were heated to 150° C., and the agitator was worked with 50 rpm to form a uniform molten state. Additionally, the mixed reactants were heated from 150° C. to 200° C. under argon atmosphere for four hours and were maintained at 200° C. until distillate of about 340 ml was obtained. Additionally, the mixed reactants were gradually heated to 230° C. for about thirty minutes and were agitated with 50 rpm at 230° C. for one hour. Thereafter, the speed of the agitator was reduced to 30 rpm, and the mixed reactants were left under vacuum of 5 torr for one hour. Then, with argon flowing, the reactants were cooled to about 150° C. The reactants were poured on a glass plate and cooled to a room temperature, so that a polyester resin A of about 2050 g was obtained.

This polyester resin has a glass transition temperature (Tg) of 67° C. As the result of measurement using gel permeation chromatography validated by the polystyrene standard sample, this polyester resin has a number-average molecular weight (Mn) of about 4400, a weight-average molecular weight (Mw) of about 9600, and a molecular weight distribution index of 2.18.

### PREPARATION EXAMPLE 2

### Preparation of Nonlinear Polyester Resin

In order to produce a toner having better fusing property than the toner composition produced using a linear resin, a polyester resin which is composed of nonlinear molecules having branch structures and allows a cationic dyeing was polymerized through a melt condensation process.

Dimethyl terephthalate 955.6 g (4.925 mol), dimethyl isophthalate 955.6 g (4.925 mol), sodium salt of dimethyl 5-sulfoisophtalate 44.5 g (0.15 mol), anhydrous trimellitic chloride 42.1 g (0.2 mol), and 1,2-propylene glycol 1520 g (20 mol) were filled into a glass reactor of 10 l equipped with a peddle type agitator and a fractional distillation column of 20 cm. Subsequent steps were performed in the same way as those of the above-discussed preparation example 1, so that a polyester resin B of about 2082 g was obtained.

This polyester resin has a glass transition temperature (Tg) of 71° C. As the result of measurement using gel permeation chromatography validated by the polystyrene standard sample, this polyester resin has a number-average molecular weight (Mn) of about 3800, a weight-average molecular weight (Mw) of about 9300, and a molecular weight distribution index of 2.4.

### PREPARATION EXAMPLE 3

### Preparation of Nonlinear Polyester Resin

A polyester resin which is composed of nonlinear molecules having more branch structures than the nonlinear polyester resin in the above-discussed preparation example 2 and allows a cationic dyeing was polymerized through a melt condensation process.

Dimethyl terephthalate 955.6 g (4.925 mol), dimethyl isophthalate 955.6 g (4.925 mol), sodium salt of dimethyl 5-sulfoisophtalate 44.5 g (0.15 mol), anhydrous trimellitic chloride 105.3 g (0.5 mol), and 1,2-propylene glycol 1520 g (20 mol) were filled into a glass reactor of 10 l equipped with a peddle type agitator and a fractional distillation column of 20 cm. Subsequent steps were performed in the same way as those of the above-discussed preparation example 1, so that a polyester resin C of about 2082 g was obtained.

This polyester resin has a glass transition temperature (Tg) of 68° C. As the result of measurement using gel permeation chromatography validated by the polystyrene standard sample, this polyester resin has a number-average molecular weight (Mn) of about 3900, a weight-average molecular weight (Mw) of about 9300, and a molecular weight distribution index of 2.4.

Table 1 shows other physical properties of the above-discussed polyester resins A, B and C.

TABLE 1

| | Average branch | | | |
|---|---|---|---|---|
| | number per | | | |
| | polymer chain | Acid value | | Melt viscosity |
| Polyester resin | (n_{b}) | (Mg KOH/g) | T_{1/2} | (Pa-s) |
| Example 1 (resin | 0 | 7 | 160 | — |
| A) | | | | |
| Example 2 (resin | 0.88 | 12 | 170 | 160 |
| B) | | | | |
| Example 3 (resin | 2.25 | 3 | 190 | 2300 |
| C) | | | | |

 Average branch number per polymer chain (n_{b}) = (molar fraction of monomer with branches) × (the number of branches per monomer with branches) × (number-average degree of polymerization of resin)

### Embodiment 1

### Production of Magenta Dye Toner Composition Using Polyester Resin C

The polyester resin C 100 g prepared in the above example 3, a magenta dye 2.1 g (BV16, BR-13, BR-27 commercially available from Jinjiang, Hangzhou, China), a charge control agent 5 g (E-88 commercially available from Orient Chemical, Osaka, Japan), a light stabilizer 2 g (Tinuvin-326 commercially available from Ciba Specialty), a paraffin wax 5 g as a fusing agent (SX-70 commercially available from Max Chemical, Daejeon, Korea), and ethyl acetate 220 g as a volatile processing aid (commercially available from Cheonan Chemical, Cheonan, Korea) were filled into a round bottom flask of 1 l equipped with an impeller type agitator and a cooler. These contents were agitated to form a mixture, heated to a temperature of 75° C. in circumfluent conditions, and mixed for ten hours. After sufficient fluidity of this resin mixture was checked, the resin mixture was agitated with 500 rpm at the same temperature for two hours and thereby finely dispersed.

Distilled water 400 g as process medium, sodium dodecyl sulfate 2.8 g (commercially available from Junsei Chemical Co., Tokyo, Japan), and polyvinyl alcohol 8 g as a thickener were filled into another round bottom flask of 1 l. These contents were agitated to form a mixture, heated to a temperature of 75° C. in circumfluent conditions, and agitated with 500 rpm for one hour, so that a dispersed solution was prepared. Then the above resin mixture was added to the dispersed solution. The mixed reactants were agitated with 1000 rpm at the same temperature for one hour, so that the resin mixture was dispersed and thereby a resin mixture dispersed solution was obtained.

Next, the resin mixture dispersed solution was agitated with a reduced agitation speed of 300 rpm at the same temperature and then heated to a temperature of 90° C. with a partially reduced pressure, so that the processing aid, ethyl acetate, was obtained through the cooler. After four hours, a complete removal of ethyl acetate was verified, and the resin mixture dispersed solution was cooled. Thereafter, toner particles were separated from medium through a conventional filter. Then a washing process was repeated to completely remove surfactant from filter cake by dispersing again obtained filter cake and filtering again it four times in distilled water. Re-filtered particles were dried in a convection oven with a temperature of 40° C. for one day. Dried toner particles 10 g and hydrophobic silica 0.07 g (TG 308F commercially available from Cabot Corp., Boston, USA) were inputted into a Wering blender and mixed with 5000 rpm for two minutes, so that toner particles were obtained.

As the result of observation using a scanning electron microscope, it was verified that the above toner particles were spherical. In addition, as the result of analysis for components of the toner particles, it was verified that a polyester resin of 86.6 weight percent, a dye of 2.1 weight percent, a wax of 4.5 weight percent, a light stabilizer of 1.9 weight percent, and a charge control agent of 4.9 weight percent were contained. Furthermore, as the result of measurement using a Coulter LS particle size analyzer (Coulter Electronics Co. Ltd., St Petersburg, Fla.), a volume average particle size was 8.3 μm, and a span value was 0.65.

### Embodiment 2

### Production of Black Dye Toner Composition Using Polyester Resin C

A toner composition was produced in the same method as in the above embodiment 1, except that a black dye 4.1 g (BB-3, BB-41, BR-18, BV-16, BY-51 commercially available from Jinjiang, Hangzhou, China) was used instead of a magenta dye 2.1 g in the embodiment 1.

As the result of observation using a scanning electron microscope, it was verified that the above toner particles were spherical. In addition, as the result of analysis for components of the toner particles, it was verified that a polyester resin of 85.0 weight percent, a dye of 3.9 weight percent, a wax of 4.5 weight percent, a light stabilizer of 1.9 weight percent, and a charge control agent of 4.7 weight percent were contained. Furthermore, as the result of measurement using a Coulter LS particle size analyzer, a volume average particle size was 7.9 μm, and a span value was 0.87.

### Embodiment 3

### Production of Yellow Dye Toner Composition Using Polyester Resin C

A toner composition was produced in the same method as in the above embodiment 1, except that a yellow dye 2.5 g (BY-51 commercially available from Jinjiang, Hangzhou, China) was used instead of a magenta dye 2.1 g in the embodiment 1.

As the result of observation using a scanning electron microscope, it was verified that the above toner particles were spherical. In addition, as the result of analysis for components of the toner particles, it was verified that a polyester resin of 86.4 weight percent, a dye of 2.3 weight percent, a wax of 4.5 weight percent, a light stabilizer of 1.9 weight percent, and a charge control agent of 4.9 weight percent were contained. Furthermore, as the result of measurement using a Coulter LS particle size analyzer, a volume average particle size was 7.9 μm, and a span value was 0.66.

### Embodiment 4

### Production of Cyan Dye Toner Composition Using Polyester Resin C

A toner composition was produced in the same method as in the above embodiment 1, except that a cyan dye 2.0 g (BB-3, BB-41 commercially available from Jinjiang, Hangzhou, China) was used instead of a magenta dye 2.1 g in the embodiment 1.

As the result of observation using a scanning electron microscope, it was verified that the above toner particles were spherical. In addition, as the result of analysis for components of the toner particles, it was verified that a polyester resin of 87.1 weight percent, a dye of 1.8 weight percent, a wax of 4.5 weight percent, a light stabilizer of 1.9 weight percent, and a charge control agent of 4.7 weight percent were contained. Furthermore, as the result of measurement using a Coulter LS particle size analyzer, a volume average particle size was 8.5 μm, and a span value was 0.65.

### Embodiment 5

### Production of Cyan Dye Toner Composition Using Polyester Resin C

First of all, the polyester resin C prepared in the above preparation example 3 and a blue dye (C. I. pigment blue 15:3, color index No. 74160, commercially available from Dain ippon Ink & Corporated (DIC), Japan) were mixed in a weight ratio of 6:4. After ethyl acetate was added up to 50% of polymer, a mixture was heated to about 60° C., agitated with a mixer, and dispersed. Thereafter, the mixture was mixed with a speed of 50 rpm using a twin extruder connected to a vacuum device, and ethyl acetate was removed using the vacuum device. So, a cyan dye master batch was produced.

The polyester resin C 85 g prepared in the above preparation example 3, the cyan dye master batch 15 g prepared above, a charge control agent 2 g (N-23 commercially available from HB Dinglong, Hubei, China), a carnauba wax 5 g (commercially available from Max Chemical, Daejeon, Korea), and ethyl acetate 150 g as a volatile processing aid (commercially available from Aldrich Chemical Company, Milwaukee, Wis.) were filled into a round bottom flask of 1 l equipped with an impeller type agitator and a cooler. These contents were agitated to form a mixture, heated to a temperature of 72° C. in circumfluent conditions, and mixed for ten hours. After sufficient fluidity of this resin mixture was checked, the resin mixture was agitated with 500 rpm at the same temperature for two hours and thereby finely dispersed.

Distilled water 400 g as process medium, polyvinyl alcohol 10 g (P-24 commercially available from DC Chemical Co., Seoul, Korea), and neutral surfactants Tween 207 g (Aldrich Co.) and sodium dodecyl sulfate 4.2 g (commercially available from Junsei Chemical Co., Tokyo, Japan) were filled into another round bottom flask of 1 l. These contents were agitated to form a mixture, heated to a temperature of 72° C. in circumfluent conditions, and agitated with 500 rpm for one hour, so that a dispersed solution was prepared. Then the above resin mixture was added to the dispersed solution. The mixed reactants were agitated with 1000 rpm at the same temperature for one hour, so that the resin mixture was dispersed and thereby a resin mixture dispersed solution was obtained.

Next, the resin mixture dispersed solution was agitated with a reduced agitation speed of 300 rpm at the same temperature and then heated to a temperature of 90° C. with a partially reduced pressure, so that the processing aid, ethyl acetate, was obtained through the cooler. After four hours, a complete removal of ethyl acetate was verified, and the resin mixture dispersed solution was cooled. Thereafter, toner particles were separated from medium through a conventional filter. Then a washing process was repeated to completely remove all of surfactant and thickener from filter cake by dispersing again obtained filter cake and filtering again it four times in distilled water. Re-filtered particles were dried in a convection oven with a temperature of 40° C. for one day. Dried toner particles 10 g and hydrophobic silica 0.07 g (TG 308F commercially available from Cabot Corp., Boston, USA) were inputted into a Wering blender and mixed with 5000 rpm for two minutes, so that toner particles were obtained.

As the result of observation using a scanning electron microscope, it was verified that the above toner particles were spherical. In addition, as the result of analysis for components of the toner particles, it was verified that a polyester resin of 87.9 weight percent, a pigment of 5.6 weight percent, a wax of 4.6 weight percent, and a charge control agent of 1.9 weight percent were contained. Furthermore, as the result of measurement using a Coulter LS particle size analyzer (Coulter Electronics Co. Ltd., St Petersburg, Fla.), a volume average particle size was 7.0 μm, and a span value was 0.62.

### COMPARATIVE EXAMPLE 1

### Production of Cyan Dye Toner Composition Using Polyester Resin B

A toner composition was produced in the same method as in the above embodiment 4, except that the polyester resin B was used instead of the polyester resin C in the embodiment 4.

As the result of analysis for components of the toner particles, it was verified that a polyester resin of 87.1 weight percent, a dye of 1.8 weight percent, a wax of 4.5 weight percent, a light stabilizer of 1.9 weight percent, and a charge control agent of 4.7 weight percent were contained. Furthermore, as the result of measurement using a Coulter LS particle size analyzer, a volume average particle size was 9.9 μm, and a span value was 0.62.

### COMPARATIVE EXAMPLE 2

### Production of Cyan Dye Toner Composition Using Polyester Resin A

A toner composition was produced in the same method as in the above embodiment 4, except that the polyester resin A was used instead of the polyester resin C in the embodiment 4.

As the result of analysis for components of the toner particles, it was verified that a polyester resin of 87.1 weight percent, a dye of 1.8 weight percent, a wax of 4.5 weight percent, a light stabilizer of 1.9 weight percent, and a charge control agent of 4.7 weight percent were contained. Furthermore, as the result of measurement using a Coulter LS particle size analyzer, a volume average particle size was 8.0 μm, and a span value was 0.60.

### EXPERIMENTAL EXAMPLE 1

### Measurement for Fusing Temperature Range of Toner Composition

In order to verify a fusing temperature range of the toner composition according to this invention, the following measurement was carried out using a dual roller type fusing device commonly used in a normal printer.

After a specific amount of the toner composition produced in the above-discussed embodiments 1˜5 and comparative examples 1˜2 was coated on paper, this was inserted with a speed of 12.5 cm per second while a temperature of the roller type fusing device was increased at 10° C. intervals from 120° C. A temperature range where an offset mark was observed from non-coated parts of paper was determined as a fusing temperature range.

Table 2 shows results of the above measurement.

TABLE 2

| Toner composition | Fusing temperature range (° C.) |
|---|---|
| Embodiment 1 | 150~220 |
| Embodiment 2 | 150~220 |
| Embodiment 3 | 150~220 |
| Embodiment 4 | 150~220 |
| Embodiment 5 | 150~220 |
| Comparative example 1 | 150~190 |
| Comparative example 2 | 130~160 |

As shown in Table 2, a fusing temperature range of the toner composition according to this invention was 150˜220° C., whereas fusing temperature ranges of the toner compositions in the comparative examples 1 and 2 were 150˜190° C. and 130˜160° C., respectively. It was therefore verified that a fusing temperature range of the toner composition according to this invention is broader. As fully discussed hereinbefore, as the average branch number per chain of the polyester resin increases, the highest fusing temperature rises, thus allowing the range of a fusing temperature of the toner composition to be widened.

### INDUSTRIAL APPLICABILITY

The toner composition according to the present invention creates entanglement between adjacent polymer chains by using the nonlinear polyester resin having a branch structure, provides elasticity to molten materials when the resin is molten, prevents the molten materials from being transferred to the hot surface of the roller, and thereby increases the highest fusing temperature. Therefore, as the average branch number per chain of the polyester resin increases, the highest fusing temperature rises, thus allowing the range of a fusing temperature of the toner composition to be widened. This toner composition having a broad range of a fusing temperature may be usefully used for laser printing devices.

1. A toner composition comprising:
a polyester resin;
a colorant;
a wax,
a light stabilizer; and
a charge control agent,
wherein the polyester resin is a nonlinear polyester resin having a branch structure in which an average branch number per chain is 2.0˜3.0, and the polyester resin has a glass transition temperature (Tg) of 45˜80° C., a number-average molecular weight (Mn) of 3000˜8000, a weight-average molecular weight (Mw) of 6000˜40000, and a molecular weight distribution index of 2.0˜13.0, and
wherein the toner composition has a spherical particle shape, a volume average particle size of 3˜10 μm, a span value of 0.1˜0.8, and a range of a fusing temperature of 150° C.˜220° C.

2. The toner composition of claim 1, wherein the nonlinear polyester resin having the branch structure is produced by polymerizing a first monomer component having three or more functional groups of carboxyl and hydroxyl and a second monomer component having bi-functional groups through a melt condensation process.

3. The toner composition of claim 2, wherein the first monomer component having three or more functional groups of carboxyl and hydroxyl includes at least one selected from the group consisting of trimellitic acid, trimesic acid, 1,3,5-tricarboxybenzene, 5-hydroxy-isophthalic acid, dihydroxy-benzoic acid, 1,3,5-benzenetriol, 1,2,4-benzenetriol, 1,3,5-benzene triacetate, glycol, and tetrahydroxy benzophenone.

4. The toner composition of claim 2, wherein the second monomer component having bi-functional groups includes at least one selected from monomer components having functional groups of dicarboxyl acid, diol, and hydroxycarboxyl acid.

5. The toner composition of claim 4, wherein the monomer component having dicarboxyl acid functional groups includes at least one selected from the group consisting of terephthalic acid and derivatives thereof, isophthalic acid and derivatives thereof, fumaric acid, succinic acid, glutaric acid, adipic acid, sebacic acid, cyclohexane dicarboxyl acid, naphthalene dicarboxyl acid and derivatives thereof, and 1,2-bis(4-carboxyphenoxy) ethane.

6. The toner composition of claim 4, wherein the monomer component having diol functional groups includes at least one selected from the group consisting of ethylene glycol, isomer of propylene glycol, isomer of butylenes glycol, isomer of pentanediol, isomer of hexanediol, isomer of cyclohexane dimethanol, hydroquinone and derivatives thereof, 2-methyl-1,3-prophandiol, neopentyl glycol, condensation polymer of bisphenol-A and ethylene oxide, and condensation polymer of bisphenol-A and propylene oxide.

7. The toner composition of claim 4, wherein the monomer component having hydroxycarboxyl acid functional groups includes at least one selected from the group consisting of glycolic acid, lactic acid, c-caprolactone, γ-butyrolactone, propiolactone, hydroxypivalic acid, lactone of hydroxypivalic acid, and isomer of hydroxybenzoic acid and derivatives thereof.

8. The toner composition of claim 1, wherein the nonlinear polyester resin having a branch structure has a functional group suitable for interaction with dyes, the functional group including at least one selected from the group consisting of sulfonyl, sulfinic, hydroxyl, alkoxy, phosphonic or derivatives thereof, phosphinic or derivatives thereof, thiol, amine, and quaternary amine.

9. The toner composition of claim 1, wherein the colorant includes at least one selected from dyes, pigment, and mixture thereof.

10. The toner composition of claim 9, wherein the dyes includes at least one selected from basic dyes, acid dyes, and reactive dyes.

11. The toner composition of claim 9, wherein the pigment includes at least one selected from the group consisting of cyan pigment, magenta pigment, yellow pigment, black pigment, and white pigment.

12. The toner composition of claim 1, wherein the wax includes at least one selected from the group consisting of ester wax, carnauba wax, polyethylene wax, polypropylene wax, bees wax, and paraffin wax.

13. The toner composition of claim 1, wherein the light stabilizer includes at least one selected from UV absorbent, hindered amine light stabilizer, and a mixture thereof.

14. The toner composition of claim 1, wherein the charge control agent includes at least one selected from a positive charge control agent, a negative control agent, and a mixture thereof.

15. The toner composition of claim 1, wherein the toner composition includes, with regard to a total weight thereof, the polyester resin of 75˜95 weight percent, the colorant of 1˜15 weight percent, the wax of 1˜15 weight percent, the light stabilizer of 0.1˜5 weight percent, and the charge control agent of 0.1˜10 weight percent.

16-27. (canceled)
